(19) United States
(12) Patent Application Publication
(10) Pub. No.: US 2023/0267434 A1
(43) Pub. Date: Aug. 24, 2023

(54) SPECIAL PURPOSE VENDING MACHINE (SPVM) AND METHODS OF USE THEREOF

(71) Applicant: Dispense, LLC, Pleasant Hill, CA (US)

(72) Inventors: Steve Smith, Pleasant Hill, CA (US); Jason Bass, Arcadia, CA (US)

(21) Appl. No.: 18/112,874

(22) Filed: Feb. 22, 2023

Related U.S. Application Data
(60) Provisional application No. 63/312,879, filed on Feb. 23, 2022.

(51) Int. Cl. G06Q 20/18; G06Q 10/087; G06K 7/14; G07F 11/52

(52) U.S. Cl. CPC G06Q 20/18; G06Q 10/087; G06K 7/1417; G07F 11/52

(57) ABSTRACT

The present disclosure relates to special purpose vending machines (SPVMs) methods of use thereof, and computer readable mediums (CRMs) for operating the same. In certain aspects, the method includes receiving personally identifying information (PII) from a user, receiving, from the user, an order to purchase at least one item, transmitting the PII to a third-party verification service (TPVS), receiving at least one user verification from the TPVS, sending a code to the user, where the code may include order data corresponding to the at least one item purchased by the user, receiving a scan of the code from the user using a special purpose vending machine (SPVM), where the SPVM houses the at least one item purchased by the user, and instructing the SPVM to dispense the at least one item purchased by the user.

### RELATED APPLICATIONS

The present application claims priority to U.S. Provisional Patent Application No. 63/312,879, filed on Feb. 23, 2022, which is incorporated by reference herein in its entirety.

### FIELD

The field of the present disclosure relates to special purpose vending machines (SPVMs), methods of use thereof, and computer readable mediums (CRMs) for operating the same.

### BACKGROUND

Vending machines are used to dispense a variety of goods, from foods and drinks to hygiene products. In recent years there has also been a demand to utilize vending machine technology for a variety of other goods such as alcohol or cannabis. However, technical obstacles to widespread adoption of vending machine technologies remain.

One such obstacle is security. Vending machines that function as a point of purchase (POP) are susceptible to break-ins due to the visibility and easy access to the items inside. Another such obstacle is inventory management. The goods in vending machines are often out of stock and are often not replenished in a timely fashion. This is because vending machines typically must be locally managed and serviced.

To solve at least the above technical problems, special purpose vending machines (SPVMs) having improved security and improved ease of inventory management are needed.

### SUMMARY

Some embodiments of the present disclosure relate to a method of operating a special purpose vending machine (SPVM.) In certain aspects, the method includes receiving personally identifying information (PII) from a user. Some embodiments may also include receiving, from the user, an order to purchase at least one item. Certain embodiments may also include transmitting the PII to a third-party verification service (TPVS). Some embodiments may also include receiving at least one user verification from the TPVS. Embodiments may also include sending a code to the user, where the code may include order data corresponding to the at least one item purchased by the user. Certain implementations may also include receiving a scan of the code from the user using the SPVM, where the SPVM houses the at least one item purchased by the user. Embodiments may also include instructing the SPVM to dispense the at least one item purchased by the user.

Some embodiments of the present disclosure may also include a non-transitory computer readable medium storing software code, the software code including instructions executable by at least one processor to: receive the PII from a user, receive, from the user, an order to purchase at least one item, transmit the PII to the TPVS, send a code to the user, where the code may include order data corresponding to the at least one item purchased by the user, receive a scan of the code from the user using the SPVM, and instruct the SPVM to dispense the at least one item purchased by the user.

Certain embodiments of the present disclosure may also relate to the SPVM. In certain implementations, the SPVM includes a code scanner that is configured to scan a code from a user, a plurality of housings, where each housing may be configured to house at least one item purchased by the user, a plurality of actuators, where each actuator may be configured to dispense the at least one item purchased by the user, a vending machine controller (VMC), and a central processing unit (CPU).

Covered embodiments are defined by the claims, not the above summary. The above summary is a high-level overview of various aspects and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

### BRIEF DESCRIPTION OF THE FIGURES

FIG. 1 is a flowchart illustrating a method, according to some embodiments of the present disclosure.

FIG. 2 is a block diagram illustrating a non-transitory computer readable medium storing software code, according to some embodiments of the present disclosure.

FIGS. 3A and 3B depict a special purpose vending machine (SPVM), according to some embodiments of the present disclosure.

### DETAILED DESCRIPTION

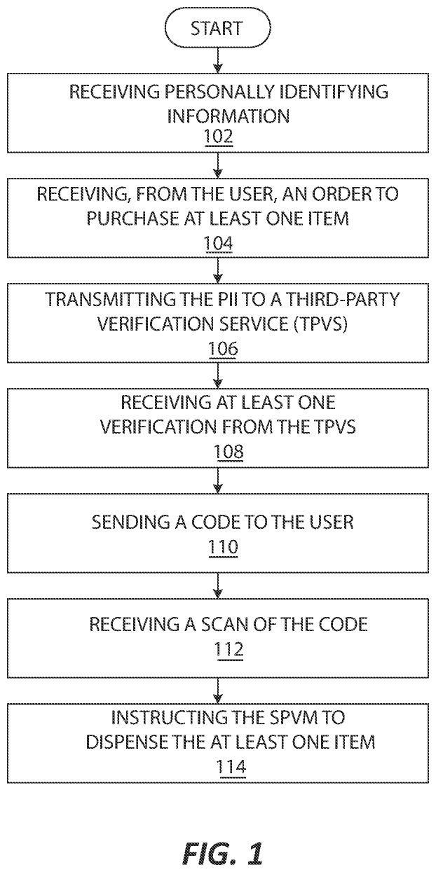

FIG. 1 is a flowchart that shows a method that utilizes a special purpose vending machine (SPVM) according to some embodiments of the present disclosure.

At 102, the method may include receiving personally identifying information (PII) from a user. In some embodiments, the PII may comprise credit card data, an age of the user, a birthdate of the user, an address of the user, a residence of the user, a medical cannabis eligibility status of the user, an identification of the at least one user, or any combination thereof.

At 104, the method may include receiving, from the user, an order to purchase at least one item. In some embodiments, the user may be a consumer. In some implementations the order may comprise alcoholic beverages, tobacco products, cannabis products, or any combination thereof.

In some embodiments, prior to receiving an order from the user, the method includes displaying a remote user interface (UI), where the remote UI prompts the user to purchase the at least one item from at least one merchant. In some examples, the method may include receiving an order confirmation from the at least one merchant.

At 106, the method may include transmitting the PII to a third-party verification service (TPVS), where the TPVS may be configured to verify the PII of the user. In some embodiments, the TPVS may be a background check service, a private database, a public database, a government database, or any combination thereof. In some examples, the TPVS is a payment processing service.

At 108, the method may include receiving at least one user verification from the TPVS. In certain examples, the TPVS may be a payment processing service and receiving the at least one user verification from the TPVS comprises receiving confirmation that the user has completed payment of the order. In some embodiments, the at least one user verification may be performed without using the SPVM. In some embodiments, the at least one user verification may be performed remotely. In certain examples, the at least one user verification comprises a payment verification from the payment processing service. In some embodiments, the at least one user verification may be performed remotely from the SPVM. In some embodiments, the at least one user verification may be transmitted remotely using a mobile device, a computer, at least one server, at least one processor, or any combination thereof. In some examples, receiving the at least one user verification from the TPVS occurs at least once before receiving the order from the user, at least once after receiving the order from the user, or any combination thereof.

At 110, the method may include sending a code to the user, where the code comprises order data corresponding to the at least one item purchased by the user. In some embodiments, where the code may comprise a bar code, a linear bar code, a discrete bar code, a matrix bar code, a black-and-white bar code, a color bar code, a polygonal bar code, a circular bar code, a customized bar code or any combination thereof. In some embodiments, the code may be a quick response (QR) code. In some instances, the order data may comprise an order number embedded in the QR code.

At 112, the method may include receiving a scan of the code from the user using the SPVM, where the SPVM houses the at least one item purchased by the user. As used herein, a “SPVM” is any vending machine that includes at least one customized or modified component as compared to a conventional vending machine (as defined herein). In some embodiments, receiving a scan of the code may comprise scanning the code using a code reader on the SPVM.

In examples in which the code is a QR code, the order number embedded in the QR code may be associated with a unique SPVM in a specific location. According to some embodiments, the QR code of the present disclosure may be utilized in an unconventional manner. In contrast to conventional QR codes, which are scanned using a mobile device, the “unconventional” QR code of some embodiments of the present disclosure can be scanned by a QR code scanner on the SPVM, initiating a cascade of steps culminating in the dispensing of the at least one item purchased by the user.

In some examples, the method may also include a step of scanning an additional QR code, where the additional QR code is a conventional QR code. As used herein, a “conventional QR code” is a QR code that is scannable by a mobile device of the user, rather than by a QR code reader on the SPVM. One example of a step of scanning a conventional QR code could occur if a user is at a location, such as a cannabis dispensary, where the SPVM is present. In some such examples, the conventional QR code can be scanned by a mobile device of the user to display, for example, a product selection of the cannabis dispensary (e.g., via calling up a web browser on the mobile device.) At that point, the product displayed can be ordered by the user in accordance with the method herein.

According to some embodiments, an exemplary method utilizing the conventional QR code may include: scanning the conventional QR code using a mobile device of a user, displaying a web page, where the web page is configured to allow the user to purchase at least one item, receiving, from the user, an order to purchase the at least one item, transmitting the PII to the TPVS, sending an additional, unconventional QR code to the user, where the unconventional QR code includes order data corresponding to the at least one item purchased by the user, receiving a scan of the unconventional QR code presented by a user to the scanner of the SPVM, and instructing the SPVM to dispense the at least one item purchased by the user.

At 114, the method may include instructing the SPVM to dispense the at least one item purchased by the user. In some examples the SPVM comprises a plurality of actuators and instructing the SPVM to dispense the at least one item purchased by the user comprises transmitting a signal to each actuator corresponding to the at least one item purchased by the user, thereby dispensing the at least one item purchased by the user. In some examples, each signal may have a specific voltage that is associated with a specific actuator as described in more detail below.

In some embodiments, the QR code may further comprise a script in addition to the order number. As per some examples, the script may initiate a cascade of operations within the SPVM, where the operations culminate in the dispensing of the at least one item purchased by the user. According to such examples, upon execution of the script by a central processing unit (CPU) of the SPVM, the script may be configured to instruct the SPVM to query an inventory management system (IMS) to verify that the order number is valid. Upon verifying that the order number is valid, the CPU would instruct the SPVM to dispense the at least one item purchased by the user. For instance, in certain implementations, after the QR code is scanned by the SPVM, the CPU may query a website. The website would then authenticate the order and, via the CPU, instruct the VMC to turn specific actuators of the SPVM, thereby dispensing the at least one item purchased by the user. In some embodiments, the script of the QR code may be a hypertext preprocessor (PHP) script. In some examples, the script may be in JavaScript, Python, Ruby, Groovy, Perl, Lua, or Bash. In some examples, if the order is not valid, a signal may be sent to the SPVM and/or the user's mobile device to notify the user.

In some embodiments, the SPVM may be configured to dispense the at least one item without the SPVM obtaining any PII from the user at any point of the method. In some embodiments, the SPVM may be configured to dispense the at least one item without serving as a point of purchase (POP) for the at least one item purchased by the user. In some examples the SPVM cannot be operated by a user and can only be operated remotely.

In some examples, the method can include remotely tracking inventory of the SPVM. In some examples, remotely tracking inventory of the IMS is performed without storing any of the order data in the SPVM. In some examples, no component of the IMS is stored on or within the SPVM. In certain implementations, the IMS consists of a plurality of remote servers and/or computing devices. In some embodiments, the IMS may be configured to track a weight of at least one product, a location of the at least one product, a quantity of the at least one product, a license number of at least one product, an identification number of at least one product, a loading date of the at least one product, a loading time of the at least one product, a sale time of the at least one product, a sale date of the at least one product, or any combination thereof. Certain implementations may include remotely tracking inventory of the SPVM using the IMS. In certain implementations the inventory can be tracked remotely without transmitting inventory data from the SPVM to the IMS. In some embodiments, the IMS may comprise a software program, a software-as-a-service (SAAS), a module on the SPVM, a database, a blockchain, or any combination thereof. In some embodiments, the IMS may be configured to send an alert to the SPVM when the at least one product is out of stock.

In certain implementations, the method may include instructing the SPVM to place a hold on a product in the SPVM to reserve the product for the user to scan the code. In certain implementations, the hold will expire if the code is not scanned by the user within a predetermined time period from when the code is sent. In certain implementations, when the hold expires, the order is cancelled. In some embodiments, the predetermined time period may be: 1 to 72 hours, 12 to 72 hours, 24 to 72 hours, 36 to 72 hours, 48 to 72 hours, 1 to 48 hours, 1 to 36, hours, 1 to 24 hours, 1 to 12 hours, 12 to 48 hours, 24 to 36 hours, or any combination thereof. In some embodiments, where the predetermined time period may be 24 hours. In certain embodiments, the method may include, removing the hold upon the SPVM receiving the scan of the code from the user.

In some embodiments, the SPVM may be obtained by retrofitting a conventional vending machine. As used herein, “a conventional vending machine” is any vending machine that serves as a POP. In some embodiments, the conventional vending machine may be a soda machine, a snack machine, a lottery machine, a toiletry machine, a slot machine, or any combination thereof. In some embodiments, retrofitting the conventional vending machine may include obtaining the conventional vending machine, switching the vending machine from the default mode, removing the payment terminal, and installing at least one customized component. In some examples, the at least one customized component comprises the code scanner, the CPU, a wiring harness, a vending machine controller (VMC), or any combination thereof.

In some examples, the default mode of the vending machine is a “vend mode,” where in “vend mode,” the CPU is in communication with a native keyboard and a native display. A user pressing the keyboard in “vend mode” would actuate a specific actuator on the vending machine associated with keys that the user pushes on the keyboard. Moreover, in vend mode, the user's selection would also be shown on the display.

Accordingly, in some examples, switching the vending machine from the default mode could include transferring the vending machine to “free mode,” where in “free mode,” the CPU could freely choose an actuator. In some implementations, switching the vending machine to free mode allows the QR code comprising a script to instruct the CPU to remotely actuate the specific housing on the vending machine that comprises the at least one item ordered by the user. In some implementations, the native keyboard and the native display may be retained as a diagnostic keyboard and a diagnostic display. For example, the native vend mode would be repurposed as a diagnostic mode, which could be used, for example, during servicing.

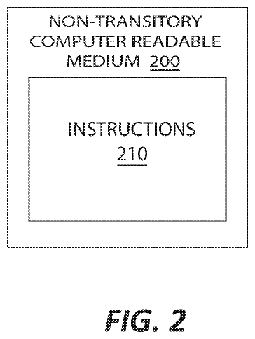

FIG. 2 is a block diagram that shows a non-transitory computer readable medium storing software code 200, according to some embodiments of the present disclosure. In some embodiments, the non-transitory computer readable medium storing software code 200 may include instructions executable by at least one processor to: receive the PII from a user, receive, from the user, an order to purchase at least one item, transmit the PII to the TPVS, send a code to the user, where the code may include order data corresponding to the at least one item purchased by the user, receive a scan of the code from the user using the SPVM, and instruct the SPVM to dispense the at least one item purchased by the user.

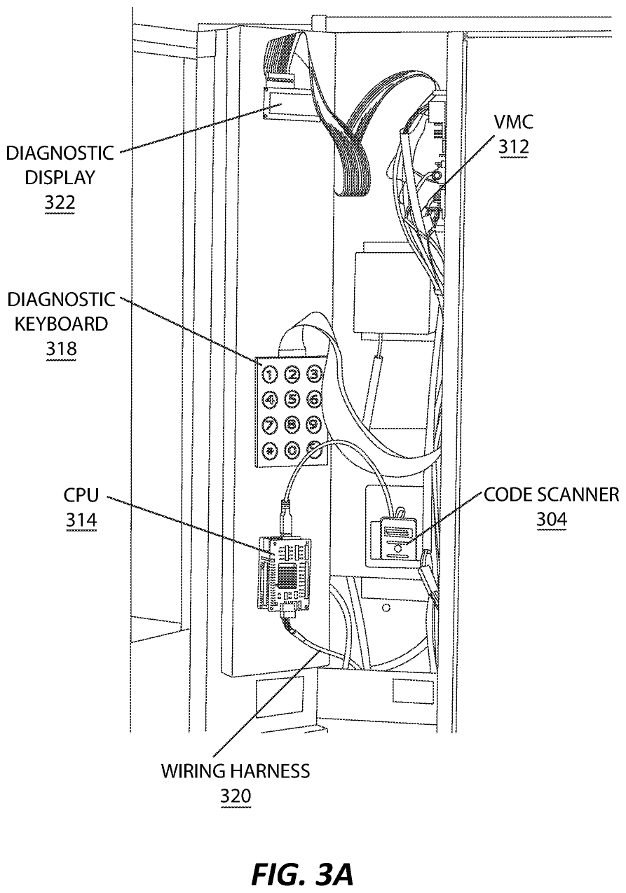

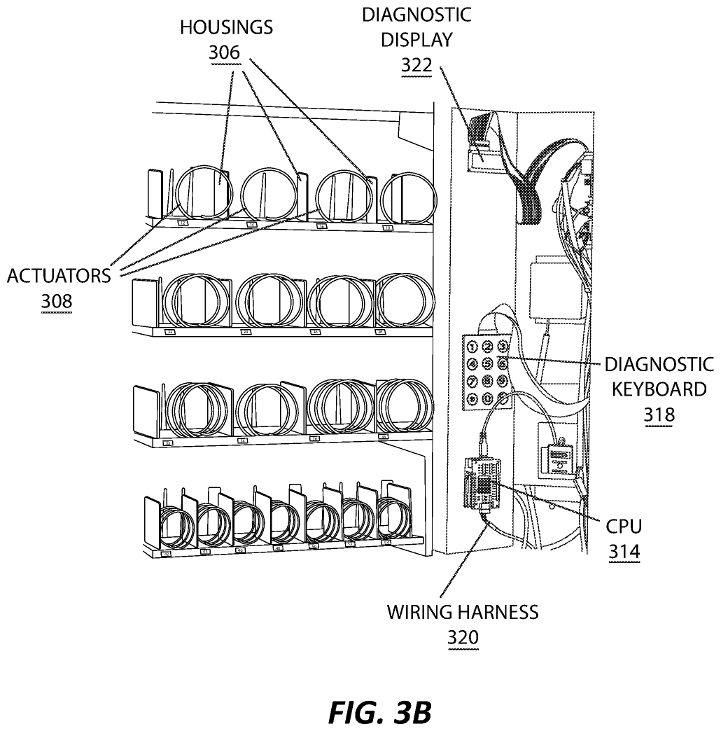

FIGS. 3A-3B depict the SPVM according to some embodiments of the present disclosure. In some examples, the SPVM comprises a code scanner 304, a plurality of housings 306, a plurality of actuators 308, VMC 312, CPU 314, diagnostic keyboard 318, wiring harness 320, and diagnostic display 322.

In some embodiments, the code scanner 304 may be configured to scan a code from a user. In some embodiments, the code is a QR code, and the scanner is a QR code scanner.

In certain examples, the plurality of housings 306 house the at least one item purchased by the user. In some examples, the plurality of actuators 308 are configured to dispense the at least one item purchased from the user upon actuation by releasing a particular item from that item's respective housing.

In some examples, at least one of the VMC 312 or the CPU 314 comprises a general-purpose processing component, a digital signal processor (DSP), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. In one non-limiting example, the VMC 312 is the AIOT-MSSP01 controller manufactured by AAEON®. In one non-limiting embodiment, the CPU 314 is Model No. UP-CHT01-A20-0464-A11 manufactured by AAEON®.

In some examples, the VMC 312 is configured to instruct the SPVM to dispense the at least one item. In some such cases, the CPU 314 may instruct the VMC 312 to send a signal to a particular actuator 308, where that actuator 308 is associated with a specific item ordered by the user. In some examples, each actuator 308 is electromechanically coupled to a motor, where each motor is configured to respond to a unique signaling condition. Accordingly, in certain implementations, the CPU 314 may instruct the VMC 312 to dispense a specific item. The VMC 312 would then communicate the signaling condition to the associated actuator 308, thereby dispensing the item ordered by the user. In one embodiment, the signaling condition is a specific voltage associated with a particular actuator 308. In some examples, each specific voltage associated with each actuator 308 could be preprogrammed into the CPU 314. The CPU 314 would then instruct the VMC 312 to emit a signal at the specific voltage associated with each item of the user's order. In certain examples, the VMC 312 would emit a voltage strictly to a specific actuator, where this specific actuator is configured to dispense a specific item purchased by the user. In other examples, the VMC 312 would emit a single voltage to the entire SPVM. In such a case, only the actuator 308 configured to dispense that specific item would be affected because only that specific actuator 308 would be programmed to respond to that voltage. Either of these mechanisms can be repeated until all items of the user's order are dispensed. These mechanisms are not meant to be limiting and any other mechanisms, whereby at least one voltage (or other signaling condition) causes the release of at least one actuator 308 to dispense at least one item from an SPVM, are intended to fall within the scope of the present disclosure.

In certain examples, the wiring harness 320 may be configured to transmit instructions (e.g., a signal at a specific voltage) to dispense at least one item purchased by the user from the CPU 314 to the VMC 312 as described above.

In some examples where the SPVM is a retrofitted version of a conventional machine the diagnostic keyboard 318 and the diagnostic display 322 may be retained from a conventional vending machine. The diagnostic keyboard 318 and the diagnostic display 322 can then be operated in a diagnostic mode.

In some embodiments, the SPVM may exclude a point of sale (POS) terminal. In some examples, the SPVM may be configured to dispense the at least one item ordered by the user without the SPVM obtaining any personally identifying information (PII) from the user. By omitting the POS terminal and abstaining from obtaining PII from the user, the SPVMs of some embodiments of the present disclosure allow for improved security both virtually (e.g., by protecting users' personal data) and on-site (e.g., by reducing the likelihood of break-ins). In addition, the remote management of SPVMs by an IMS according to some embodiments the present disclosure can allow for improved management and control of inventory since the SPVMs may not require on-site maintenance.

In some embodiments, the present disclosure may relate to a method comprising: receiving personally identifying information (PII) from a user; receiving, from the user, an order to purchase at least one item; transmitting the PII to a third-party verification service (TPVS), where the TPVS is configured to verify the PII of the user; receiving at least one user verification from the TPVS; sending a code to the user, where the code comprises order data corresponding to the at least one item purchased by the user; receiving a scan of the code from the user using a special purpose vending machine (SPVM), where the SPVM houses the at least one item purchased by the user; and instructing the SPVM to dispense the at least one item purchased by the user. The method of embodiment 1, where the TPVS is a payment processing service, and where receiving the at least one user verification from the TPVS comprises receiving confirmation that the user has completed payment of the order.

In certain embodiments, the at least one user verification is performed remotely from the SPVM.

In some examples, the PII comprises credit card data, an age of the user, a birthdate of the user, an address of the user, a residence of the user, a medical cannabis eligibility status of the user, an identification of the at least one user, or any combination thereof.

In certain implementations, the TPVS is a background check service, a private database, a public database, a government database, or any combination thereof.

In some instances, the user is a consumer.

Some embodiments may include the at least one user verification being performed without using the SPVM.

In certain examples, the at least one user verification is transmitted remotely using a mobile device, a computer, at least one server, at least one processor, or any combination thereof.

In certain implementations, prior to receiving an order from the user, embodiments of the present disclosure may include displaying a remote user interface (UI), where the remote UI prompts the user to purchase the at least one item from at least one merchant.

In certain examples, the order comprises alcoholic beverages, tobacco products, cannabis products, or any combination thereof.

In some embodiments, the code comprises a bar code, a linear bar code, a discrete bar code, a matrix bar code, a black-and-white bar code, a color bar code, a polygonal bar code, a circular bar code, a customized bar code or any combination thereof.

Some embodiments may include the code being a quick response (QR) code.

The order data, may, in some implementations, include an order number, where the order number is embedded in the QR code, and where the order number corresponds to a unique SPVM in a specific location.

The receiving of the scan of the code may, in some instances, be performed using a code scanner on the SPVM.

The SPVM may be obtained by retrofitting a conventional vending machine.

The conventional vending machine could be a soda machine, a snack machine, a lottery machine, a toiletry machine, a slot machine, or any combination thereof.

Certain instances may include the SPVM being configured to dispense the at least one item without the SPVM obtaining any PII from the user.

In some cases, the QR code further comprises a script. Upon execution of the script by a central processing unit (CPU) of the SPVM, the script may be configured to: query an inventory management system (IMS) to verify that the order number is valid. The script may further be configured to instruct the SPVM to dispense the at least one item purchased by the user upon verification that the order number is valid.

In certain implementations, the SPVM comprises a plurality of actuators, where each actuator is configured to dispense a product housed in the SPVM.

In some embodiments, instructing the SPVM to dispense the at least one item purchased by the user comprises transmitting a signal to each actuator corresponding to the at least one item purchased by the user, thereby dispensing the at least one item purchased by the user.

In certain implementations, the SPVM is configured to dispense the at least one item without serving as a point of purchase (POP) for the at least one item purchased by the user.

Some aspects of the method may comprise remotely tracking inventory of the SPVM using the IMS without storing any of the order data in the SPVM.

In some embodiments, remotely tracking inventory of the SPVM does not comprise transmitting inventory data from the SPVM to the IMS.

The IMS may, in some embodiments, comprise a software program, a software-as-a-service (SAAS), a module on the SPVM, a database, a blockchain, or any combination thereof.

The IMS may be configured to track: a weight of at least one product, a location of the at least one product, a quantity of the at least one product, a license number of at least one product, an identification number of at least one product, a loading date of the at least one product, a loading time of the at least one product, a sale time of the at least one product, a sale date of the at least one product, or any combination thereof.

In some examples, the IMS is configured to send an alert to the SPVM when the at least one product is out of stock.

Some embodiments of the method further comprise instructing the SPVM to place a hold on the order if the code is not scanned by the user within a predetermined time period from when the code is sent.

In some examples, the predetermined time period is from 1 to 72 hours.

In some examples, the method further comprises removing the hold upon the SPVM receiving the scan of the code from the user.

In some examples, the predetermined time period is 24 hours.

In some examples, receiving at least one user verification from the TPVS occurs at least once before receiving the order from the user, at least once after receiving the order from the user, or any combination thereof.

Some implementations may include a method where receiving the at least one user verification from the TPVS comprises: receiving an order confirmation from the at least one merchant; and receiving a payment verification from the payment processing service.

In certain examples, the script is a hypertext preprocessor (PHP) script.

Some aspects of the present disclosure are directed to a non-transitory computer readable medium storing software code, the software code comprising instructions executable by at least one processor to: receive personally identifying information (PII) from a user; receive, from the user, an order to purchase at least one item; transmit the PII to a third-party verification service (TPVS), where the TPVS is configured to verify the PII of the user; receive at least one user verification from the TPVS; send a code to the user, where the code comprises order data corresponding to the at least one item purchased by the user; receive a scan of the code from the user using a special purpose vending machine (SPVM), where the SPVM houses the at least one item purchased by the user; and instruct the SPVM to dispense the at least one item purchased by the user.

Embodiments of the present disclosure may include a special purpose vending machine (SPVM) comprising: a code scanner, where the code scanner is configured to scan a code from a user, where the code comprises order data corresponding to at least one item purchased by the user; a plurality of housings, where each housing is configured to house the at least one item purchased by the user; and a plurality of actuators, where each actuator is configured to dispense the at least one item purchased by the user; where the SPVM does not comprise a point of sale (POS) terminal, and where the SPVM is configured to dispense the at least one item without the SPVM obtaining any personally identifying information (PII) from the user.

Certain aspects may include a vending machine controller (VMC), where the VMC is configured to instruct the SPVM to dispense the at least one item.

Some embodiments of the SPVM may comprise a central processing unit (CPU).

In some embodiments, the code further comprises a script and an order number and where, upon execution of the script by the CPU of the SPVM, the CPU is configured to: query an inventory management system (IMS) to verify that the order number is valid; and upon verifying that the order number is valid, instruct the VMC to dispense at least one item purchased by the user.

In certain examples, the SPVM further comprises a wiring harness, where the wiring harness is configured to transmit instructions to dispense at least one item purchased by the user from the CPU to the VMC.

In certain implementations the SPVM includes at least one diagnostic interface.

In this disclosure and the following claims, the word “or” indicates an inclusive list such that, for example, the list of X, Y, or Z means X or Y or Z or XY or XZ or YZ or XYZ. Also, the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

1. A special purpose vending machine (SPVM) comprising:
a code scanner, where the code scanner is configured to scan a code from a user, where the code comprises order data corresponding to at least one item purchased by the user;
a plurality of housings, where each housing is configured to house the at least one item purchased by the user; and
a plurality of actuators, where each actuator is configured to dispense the at least one item purchased by the user;
where the SPVM does not comprise a point of sale (POS) terminal, and
where the SPVM is configured to dispense the at least one item without the SPVM obtaining any personally identifying information (PII) from the user.

2. The SPVM of claim 1, further comprising a vending machine controller (VMC), where the VMC is configured to instruct the SPVM to dispense the at least one item.

3. The SPVM of claim 1, further comprising a central processing unit (CPU).

4. The SPVM of claim 1, where the code further comprises a script and an order number and where, upon execution of the script by the CPU of the SPVM, the CPU is configured to:
query an inventory management system (IMS) to verify that the order number is valid; and
upon verifying that the order number is valid, instruct the VMC to dispense at least one item purchased by the user.

5. The SPVM of claim 2, where the SPVM further comprises a wiring harness, where the wiring harness is configured to transmit instructions to dispense at least one item purchased by the user from the CPU to the VMC.

6. The SPVM of claim 1, further comprising at least one diagnostic interface.

7. The SPVM of claim 1, where the PII is obtained by a third-party verification service (TPVS).

8. The SPVM of claim 7, where the SPVM is configured to receive at least one user verification from the TPVS.

9. The SPVM of claim 8, where upon receiving the at least one user verification, the SPVM is configured to send the code to the user.

10. The SPVM of claim 7, where the TPVS is a payment processing service, and where receiving the at least one verification from the TPVS comprises receiving confirmation that the user has completed payment of the order.

11. The SPVM of claim 7, where the PII comprises credit card data, an age of the user, a birthdate of the user, an address of the user, a residence of the user, a medical cannabis eligibility status of the user, an identification of the at least one user, or any combination thereof.

12. The SPVM of claim 7, where the TPVS is a background check service, a private database, a public database, a government database, or any combination thereof.

13. The SPVM of claim 1, where the user is a consumer.

14. The SPVM of claim 1, where the code comprises a bar code, a linear bar code, a discrete bar code, a matrix bar code, a black-and-white bar code, a color bar code, a polygonal bar code, a circular bar code, a customized bar code or any combination thereof.

15. The SPVM of claim 1, where the code is a quick response (QR) code.

16. The SPVM of claim 15, where the order data comprises an order number, where the order number is embedded in the QR code.

17. The SPVM of claim 15, where the QR code further comprises a script, where, upon execution of the script by a central processing unit (CPU) of the SPVM, the script is configured to:
query an inventory management system (IMS) to verify that the order number is valid; and
upon verifying that the order number is valid, instruct the SPVM to dispense the at least one item purchased by the user.

18. The SPVM of claim 17, where the IMS is configured to send an alert to the SPVM when the at least one product is out of stock.

19. The SPVM of claim 17, where the IMS comprises a software program, a software-as-a-service (SAAS), a module on the SPVM, a database, a blockchain, or any combination thereof.

20. The SPVM of claim 17, where the IMS is configured to track: a weight of at least one product, a location of the at least one product, a quantity of the at least one product, a license number of at least one product, an identification number of at least one product, a loading date of the at least one product, a loading time of the at least one product, a sale time of the at least one product, a sale date of the at least one product, or any combination thereof.
